(19) United States
(12) Patent Application Publication
(10) Pub. No.: US 2007/0018938 A1
(43) Pub. Date: Jan. 25, 2007

(54) SOURCE DRIVING DEVICE AND DRIVING METHOD FOR LIQUID CRYSTAL DISPLAY PANEL

(76) Inventors: Yen-Chang Wei, Taoyuan County (TW); Hung-Shiang Chen, Taipei County (TW); Juin-Ying Huang, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/161,849

(22) Filed: Aug. 19, 2005

(30) Foreign Application Priority Data
Jul. 20, 2005 (TW) 94124261

(51) Int. Cl. G09G 3/36

(52) U.S. Cl. 345/100

(57) ABSTRACT

A source driving device and a driving method for a display panel of a liquid crystal display are provided. The source driving device comprises a source driver and a current regulator. The source driver receives image data and then outputs image data via a plurality of source lines to drive the display panel. The current regulator is electrically connected to the source driver. By evaluating the image data received by the source driver, when the voltage difference between any two adjacent source lines caused by the image data is larger than a predetermined value, the current regulator is activated to adjust the driving current on the source lines, such as reducing the driving current, to prevent the block dim phenomenon.

### CROSS-REFERENCE TO RELATED APPLICATION

This application claims the priority benefit of Taiwan application serial no. 94124261, filed on Jul. 20, 2005. All disclosure of the Taiwan application is incorporated herein by reference.

### BACKGROUND OF THE INVENTION

1. Field of the Invention

The present invention relates to a source driving device, and particularly to a source driving device for adjusting the driving current on the source lines to prevent the block dim phenomenon and the driving method thereof.

2. Description of Related Art

Following the advancement of the technology, video devices have become common in everyday life, in which displays are indispensable elements. Through displays, users can read information or even indirectly control devices. Nowadays, flat panel displays (FPD) have gradually taken over conventional cathode ray tube (CRT) displays. According to the fabrication methods, FPDs are generally divided into liquid crystal displays (LCD), plasma display panels (PDP), organic light emitting diode (OLED) displays, and field emission displays (FED) etc.

FIG. 1A is a block diagram of a display panel driving device of an LCD. Referring to FIG. 1A, a display panel driving device 100 comprises a display panel 110, a source driver 120 and a gate driver 130, wherein the display panel 110 comprises m source lines (marked as SL1 to SLm) and n gate lines (marked as GL1 to GLn) interlacing in a matrix, each intersection of the source lines and the gate lines representing a pixel 115.

The gate driver 130 drives gate lines of the display panel 110 one by one to activate the pixels on every gate line in sequence. The source driver 120 receives image data, and drives the panel display 100 to display images by inputting the corresponding image data via the source lines when the gate lines are driven one by one.

FIG. 1B is a schematic diagram of a pixel of the display panel shown in FIG. 1A. Referring to FIG. 1B, pixel 115 comprises a transistor T as a switch component, and a storage capacitance Cst for storing data. Some parasitic capacitance Cgs may exist between the gate lines and the source lines. When the source driver 120 transmits the received image data to source lines to drive the pixel 115, a return current is generated through the parasitic capacitance Cgs at the instant of the polarity conversion of the transmitted image data on the source lines. The return current returns back to the gate driver 130 via the gate lines.

In fact, the gate driver 130 includes a plurality of gate driver chips, each of which is responsible for driving a plurality of gate lines. Therefore, traces are needed among the gate driver chips for data transmission. According to the conventional technology, the trace impedance for gate signals, formed on a printed circuit board (PCB), is about 0.5Ω.

However, for the purpose of reducing the cost, increasing the reliability and miniaturizing the products, currently the gate driver 130 generally employs a chip on glass (COG) process, directly forming a gate driver chip on the display panel, in which the substrate is made of glass material. Unfortunately, the trace impedance on the glass substrate is about 15 to 100Ω, which is tens times larger than the conventional one.

The return current, caused by the parasitic capacitance Cgs, flows through the gate driver 130 via the gate lines, and through the traces on the glass substrate. The voltage difference caused by the impedance of the traces on the glass substrate can therefore make the driving voltage output from each of the gate driver chips inconsistent. As a result, the block dim phenomenon will occur among the display ranges driven by different gate driver chips.

### SUMMARY OF THE INVENTION

An object of the present invention is to provide a source driving device, for preventing the block dim phenomenon by adjusting the driving current on the source lines according to the image to be displayed.

Another object of the present invention is to provide a method for driving a display panel, whereby the return current can be reduced and the block dim phenomenon can be prevented.

The present invention provides a source driving device for a display panel of an LCD, comprising a source driver and a current regulator. The source driver receives image data and then outputs the image data via a plurality of source lines to drive the display panel to show an image. The current regulator is electrically connected to the source driver. By evaluating the image data received by the source driver, if the voltage difference between any two adjacent source lines is larger than a predetermined value, the current regulator is then activated to adjust the driving current on the source lines, such as reducing the driving current.

According to an embodiment of the present invention, the source driving device further comprises a memory, such as a static random access memory (SRAM), for the purpose of temporarily storing the image data. Moreover, the present invention is generally applied to the LCDs utilizing thin film transistors (TFTs) as switch components, particularly the TFT-LCDs fabricated in a COG process.

The present invention provides a method for driving a display panel of an LCD, the display panel being driven by a plurality of source lines. This method comprises: receiving image data; evaluating the image data and if the voltage difference between any two adjacent source lines is larger than a predetermined value, adjusting the driving current on the source lines, such as reducing the driving current; and driving the display panel with the adjusted driving current to show an images via the source lines. In one embodiment, if the voltage difference between any two adjacent source lines is larger than a predetermined value, either the driving current on the source lines or the driving current on the above described two adjacent source lines is reduced.

According to the present invention, the return current can be reduced to prevent the block dim phenomenon by evaluating the received image data and then adjusting the driving current for driving the display panel.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a block diagram of a display panel driving device of an LCD.

FIG. 1B is a schematic diagram of a pixel of the display panel shown in FIG. 1A.

FIG. 2 is a block diagram of a source driving device and a display panel driving device according to an embodiment of the present invention.

FIG. 3 is an oscillogram for comparing the waveform variation of the gate lines voltage caused by the parasite capacitors of the prior art and the embodiment of the present invention.

FIG. 4 is a flowchart of the method for driving a display panel according to an embodiment of the present invention.

### DESCRIPTION OF THE EMBODIMENTS

According to the present invention, a source driving device and a method for driving a display panel are provided to prevent the block dim phenomenon in LCDs, wherein the driving current is adjusted to reduce the return current on the gate lines. Further, the present invention is generally applied to the LCDs utilizing TFT as switching components, particularly in the TFT-LCDs whose gate drivers are directly formed on the glass substrate in a COG process.

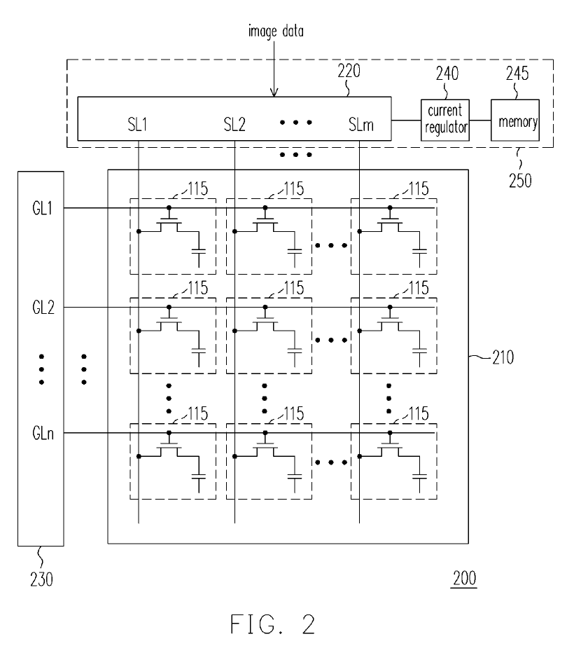

FIG. 2 is a diagram of a source driving device and a display panel driving device, according to an embodiment of the present invention. Referring to FIG. 2, a display panel driving device 200 comprises a display panel 210, a source driving device 250 and a gate driver 230, wherein the display panel 210 has m source lines marked as SL1 to SLm and n gate lines marked as GL1 to GLn interlacing in a matrix, each intersection of the source lines and the gate lines representing a pixel.

In order to adjust the driving current on the source lines, the present invented source driving device 250 comprises a source driver 220, a current regulator 240 and a memory 245. The source driver 220 receives image data, and drives the display panel 210 to show images via the source lines SL1 to SLm. The current regulator 240 is electrically connected to the source driver 220 to evaluating the image data received by the source driver 220. Furthermore, the memory 245 is electrically connected to the current regulator 240 for temporarily storing the image data which is then provided to the current regulator 240 for evaluation, wherein the memory 245 can be a volatile memory such as a SRAM.

If the voltage difference between any two adjacent source lines is larger than a predetermined value, it represents that the return current is too large. The current regulator 240 is then activated to adjust the driving current on the source lines SL1 to SLm, such as reducing the driving current. Afterwards, the return current can be indirectly reduced, whereby reducing the difference of the driving voltages output from the driver chips of the gate driver 230, to avoid the block dim phenomenon.

Although the gate driver 230 is directly made on the glass substrate of the display panel with a COG process, the current regulator 240 can be formed on the printed circuit board (PCB), i.e. it can be formed with the source driver 220 on the same circuit board, or even integrated as an application specific integrated circuit (ASIC) chip.

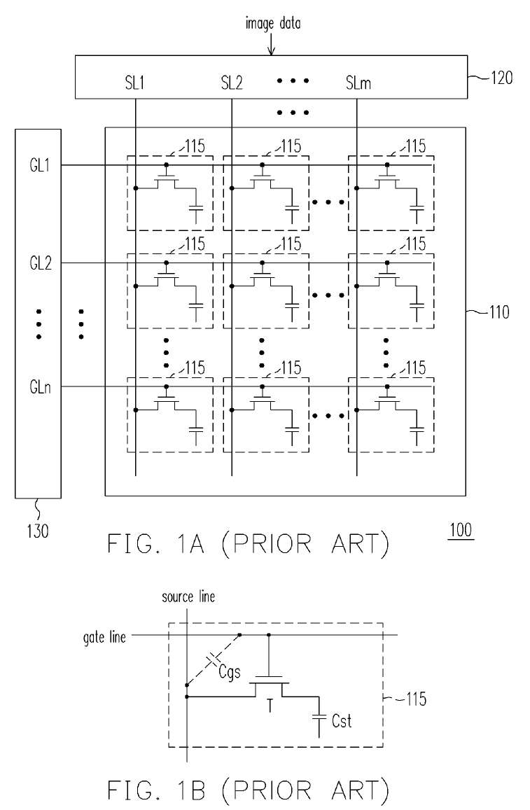

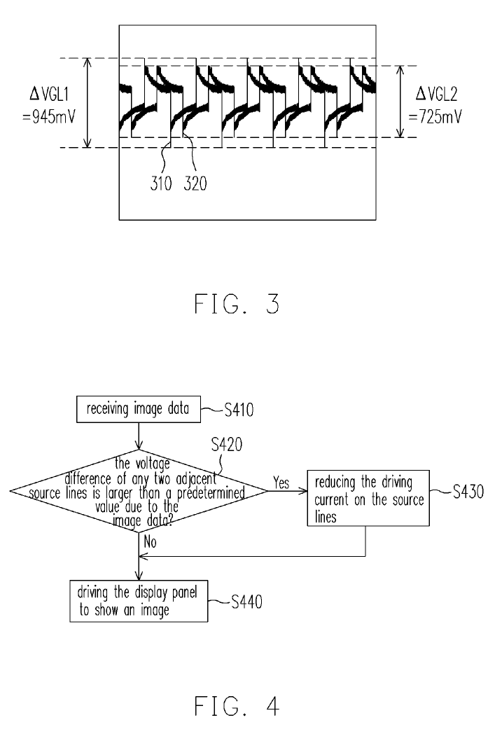

FIG. 3 is an oscillogram for comparing the waveform variation of the gate lines voltage caused by the parasite capacitors of the prior art and the embodiment of the present invention. Referring to FIG. 3, a conventional parasite capacitor Cgs as shown in FIG. 1B causes a voltage waveform 310, leading to 945 mV of difference of the driving voltage ΔVGL1 on the gate lines. Comparatively, a voltage waveform 320 is caused by the present invented source driving device, showing 725 mV of the difference of the driving voltage ΔVGL2 on the gate lines. It can be concluded that the present invention can substantially reduce the difference of driving voltage on the gate lines, thus preventing the block dim phenomenon.

As shown in FIG. 4, a flowchart of a method for driving a display panel according to the present invention is also provided. For a clear explanation, please refer to the method flowchart shown in FIG. 4 together with the device shown in FIG. 2. First, at the step S410, the source driver 220 receives the image data; the current regulator 240 evaluates the received image data at the step S420.

If the voltage difference between any two adjacent source lines SL1 to SLm is larger than a predetermined value, then go to step S430, a current regulator 240 is activated for adjusting (mostly reducing) the driving current on the source lines SL1 to SLm; then the adjusted driving current drives the display panel via the source lines SL1 to SLm to show images at step S440. On the other hand, if the voltage difference between any two adjacent source lines SL1 to SLm is not larger than a predetermined value, then go to step S440 to drive the display panel to show images. In other embodiments, it can be designed to adjust the driving current on the foregoing any two adjacent source lines.

In view of the above, the present invention provides a source driving device and a method for driving a display panel wherein the return current returning back to the source driver can be reduced by evaluating the received image data and adjusting the driving current for driving the display panel, thus preventing the block dim phenomenon.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A source driving device, for driving a display panel of a liquid crystal display (LCD), the source driving device comprising:
a source driver, for receiving image data and the image data outputted by a plurality of source lines driving the display panel to show an image; and
a current regulator, electrically connected to the source driver, wherein said current regulator is activated to adjust the driving current output by the source driver via the plurality of source lines, when the voltage difference of any two adjacent source lines is larger than a predetermined value.

2. The source driving device according to claim 1, further comprising a memory temporarily storing the image data.

3. The source driving device according to claim 2, wherein the memory is a static random access memory.

4. The source driving device according to claim 1, wherein the LCD is a thin film transistor liquid crystal display (TFT-LCD).

5. A method for driving a display panel of an LCD, wherein the display panel is driven by a plurality of source lines, the method comprising:
receiving image data;
evaluating the image data, and adjusting the driving current on the plurality of source lines when the voltage difference of any two adjacent source lines is larger than a predetermined value; and
driving the display panel to show an image with the adjusted driving current by the plurality of source lines.

6. The method for driving a display panel according to claim 5, wherein the driving current on the plurality of source lines is reduced when the voltage difference of any two adjacent source lines is larger than a predetermined value.

7. The method for driving a display panel according to claim 5, wherein the driving current on said any two adjacent source lines is reduced when the voltage difference of any two adjacent source lines is larger than a predetermined value.
